(19) United States
(12) Patent Application Publication
(10) Pub. No.: US 2025/0218686 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Jin Hwan KIM, Suwon-si (KR); Ho In JUN, Suwon-si (KR); Seong Min KWON, Suwon-si (KR); Kyo Sik KIM, Suwon-si (KR)

(73) Assignee: SAMSUNG ELECTRO-MECHANICS CO., LTD., Suwon-si (KR)

(21) Appl. No.: 18/962,056

(22) Filed: Nov. 27, 2024

(30) Foreign Application Priority Data
Dec. 29, 2023 (KR) 10-2023-0196566

(51) Int. Cl. H01G 4/30; H01G 4/008; H01G 4/012; H01G 4/12; H01G 4/232

(52) U.S. Cl. CPC H01G 4/30; H01G 4/008; H01G 4/012; H01G 4/12; H01G 4/232

(57) ABSTRACT

A multilayer electronic component includes a body including a dielectric layer and internal electrodes alternately arranged in a first direction with the dielectric layer interposed therebetween, an extension portion disposed on the body, and an external electrode arranged on the extension portion, wherein the extension portion includes a plurality of lead electrodes spaced apart in a second direction, perpendicular to the first direction, a plurality of via electrodes connecting the plurality of lead electrodes, and an insulating portion covering the plurality of lead electrodes.

### CROSS-REFERENCE TO RELATED APPLICATION(S)

This application claims the benefit of priority to Korean Patent Application No. 10-2023-0196566 filed on Dec. 29, 2023 in the Korean Intellectual Property Office, the disclosure of which is incorporated herein by reference in its entirety.

### TECHNICAL FIELD

The present disclosure relates to a multilayer electronic component.

### BACKGROUND

Multilayer ceramic capacitors (MLCCs), multilayer electronic components, are chip-type condensers mounted on the printed circuit boards of various electronic products including display devices, such as liquid crystal displays (LCDs) and plasma display panels (PDPs), computers, smartphones, cell phones, and the like, to charge or discharge electricity therein or therefrom.

MLCCs, having advantages, such as a small size, high capacitance, ease of mounting, or the like, may be used as components in various electronic devices. As various electronic devices, such as computers and mobile devices, become smaller and have higher output, demand for miniaturization and high capacitance of MLCCs has increased.

In the related art, in order to minimize the proportion of external electrodes in the entire multilayer ceramic capacitor and minimize the area in which the external electrodes are exposed to the outside of the multilayer ceramic capacitor, there has been an attempt to introduce a structure in which a separate lead electrode is formed on a cross-section of a body in which one end of an internal electrode is exposed, the lead electrode is covered with a ceramic layer, and the lead electrode is exposed only to one surface in a thickness direction. In the case of the structure, the proportion of the external electrode in the multilayer ceramic capacitor may be minimized and moisture resistance reliability may be improved, but it may be difficult to sufficiently secure electrical connectivity between the internal electrode and the lead electrode and between the lead electrode and the external electrode, and thus, the ESR of the multilayer ceramic capacitor may increase.

Therefore, there is a need for structural improvement that may prevent the reduction in the ESR characteristics although a separate lead electrode is formed on the cross-section of the body in which one end of the internal electrode is exposed.

### SUMMARY

An aspect of the present disclosure is to reduce the ESR of a multilayer electronic component in a structure in which a separate lead electrode is formed on a cross-section of a body in which one end of an internal electrode is exposed.

However, the object of the present disclosure is not limited to the aforementioned contents and may be more easily understood in the process of describing specific exemplary embodiments in the present disclosure.

According to an aspect of the present disclosure, a multilayer electronic component includes: a body including a dielectric layer and internal electrodes alternately arranged in a first direction with the dielectric layer interposed therebetween; an extension portion disposed on the body; and an external electrode disposed on one of the surfaces of the extension portion opposing each other in the first direction, wherein the extension portion includes a plurality of lead electrodes spaced apart in a second direction, perpendicular to the first direction, a plurality of via electrodes connecting the plurality of lead electrodes, and an insulating portion covering the plurality of lead electrodes. One of the plurality of lead electrodes contacts the internal electrodes.

### BRIEF DESCRIPTION OF DRAWINGS

The aspects, features, and advantages of the present disclosure will be more clearly understood from the following detailed description, taken in conjunction with the accompanying drawings, in which:

FIG. 1 is a schematic perspective view of a multilayer electronic component according to an exemplary embodiment in the present disclosure;

FIG. 2 is a cross-sectional view taken along line I-I of FIG. 1;

FIG. 3 is a cross-sectional view taken along line II-II of FIG. 1;

FIG. 4 is a schematic perspective view of a body according to an exemplary embodiment;

FIG. 5 is a schematic exploded perspective view of a multilayer electronic component according to an exemplary embodiment;

FIG. 6 is an enlarged view of region P of FIG. 2;

FIG. 7 is a schematic cross-sectional view of a multilayer electronic component according to an exemplary embodiment corresponding to FIG. 2; and

FIG. 8 is an enlarged view of region P′ of FIG. 7.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, a first direction may be defined as a stacking direction or thickness (T) direction, a second direction as a length (L) direction, and a third direction as a width (W) direction.

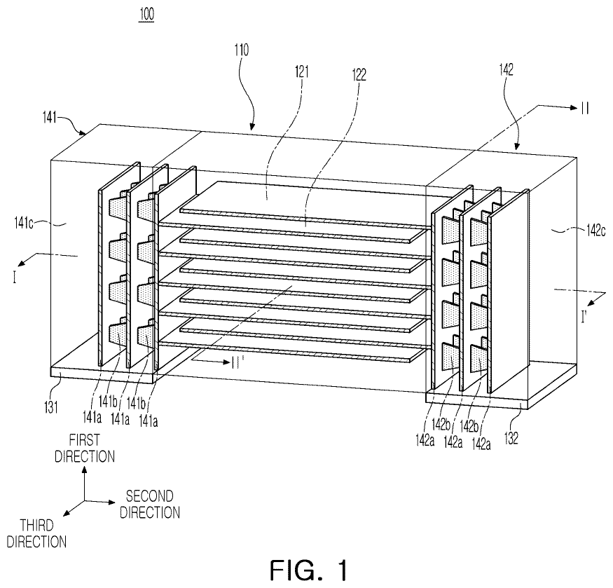

FIG. 1 is a schematic perspective view of a multilayer electronic component according to an exemplary embodiment in the present disclosure.

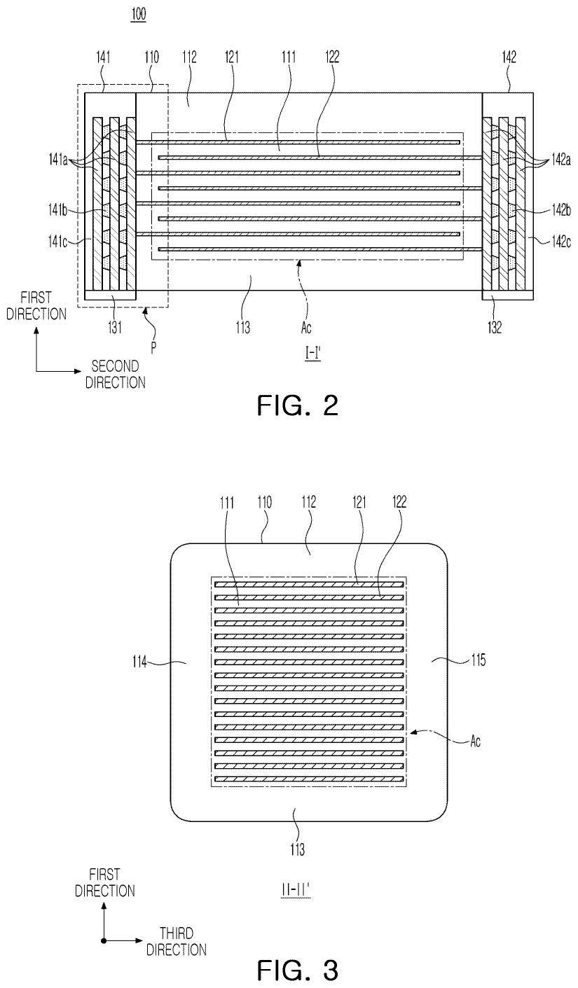

FIG. 2 is a cross-sectional view taken along line I-I of FIG. 1.

FIG. 3 is a cross-sectional view taken along line II-II of FIG. 1.

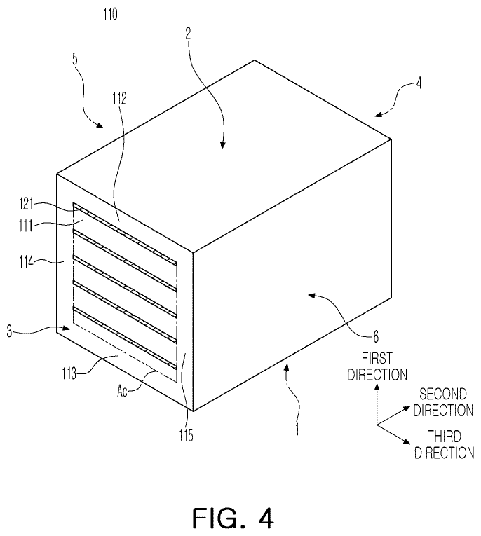

FIG. 4 is a schematic perspective view of a body according to an exemplary embodiment.

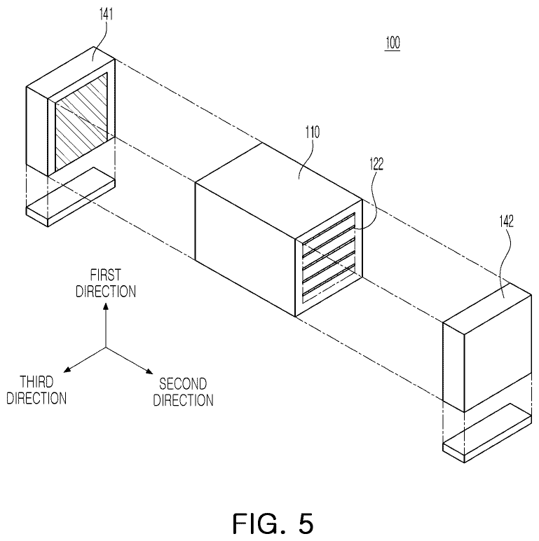

FIG. 5 is a schematic exploded perspective view of a multilayer electronic component according to an exemplary embodiment.

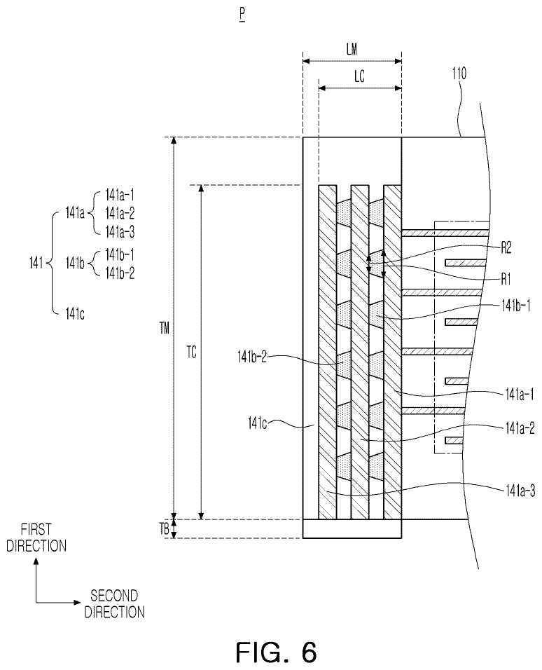

FIG. 6 is an enlarged view of region P of FIG. 2.

Hereinafter, a multilayer electronic component 100 according to an exemplary embodiment in the present disclosure will be described in detail with reference to FIGS. 1 to 6.

A multilayer electronic component 100 according to an exemplary embodiment in the present disclosure may include a body 110 including a dielectric layer 111 and internal electrodes 121 and 122 alternately stacked in a first direction with the dielectric layer 111 interposed therebetween, extension portions 141 and 142 disposed on the body 110, and external electrodes 131 and 132 disposed on one of the surfaces of the extension portions 141 and 142 opposing each other in the first direction. The extension portions 141 and 142 may respectively include a plurality of lead electrodes 141a and a plurality of lead electrodes 142a arranged at intervals in a second direction, perpendicular to the first direction of the body 110, a plurality of via electrodes 141b and 142b connecting the plurality of lead electrodes 141a and 142a, and insulating portions 141c and 142c covering the plurality of lead electrodes 141a and 142a. One of each of the plurality of lead electrodes 141a and 142a respectively contacts the internal electrodes 121 and 122 alternately exposed through surfaces of the body opposing each other in the second direction.

Referring to FIGS. 2 and 3, the body 110 may include the dielectric layer 111 and the internal electrodes 121 and 122.

The plurality of dielectric layers 111 forming the body 110 are in a sintered state, and adjacent dielectric layers 111 may be integrated such that boundaries therebetween may not be readily apparent without using a scanning electron microscope (SEM).

The raw material forming the dielectric layer 111 is not particularly limited as long as the raw material may obtain sufficient capacitance. For example, a barium titanate (BaTiO₃)-based dielectric material, a CaZrO₃-based paraelectric dielectric material, etc. may be used. For example, the barium titanate (BaTiO₃)-based dielectric material may be one or more of BaTiO₃, (Ba₁₋ₓCaₓ)TiO₃ (0<x<1), Ba(Ti_{1-y}Ca_{y})O3 (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and the CaZrO3-based paraelectric material may be (Ca₁₋ₓSrₓ)(Zr_{1-y}Ti_{y})O₃ (0<x<1, 0<y<1).

In addition, various ceramic additives, organic solvents, binders, dispersants, etc. may be added to the dielectric layer 111 according to the purpose of the present disclosure.

An average thickness of the dielectric layer 111 is not particularly limited.

In order to achieve miniaturization and high capacitance of the multilayer electronic component 100, the average thickness td of the dielectric layer 111 may be 0.35 μm or less, and in order to improve the reliability of the multilayer electronic component 1000 under high temperature and high pressure, the average thickness td of the dielectric layer 111 may be 3 μm or more.

The average thickness of the dielectric layer 111 may be measured by scanning an image of the cross-sections (L-T cross-sections) of the body 110 in the third and first directions using a scanning electron microscope (SEM).

For example, the average thickness td of the dielectric layer 111 is measured as follows. In an image of a cross-section of the body 110 in length and thickness directions (L-T) taken at the center of the body 110 in the width direction scanned with a scanning electron microscope, a total of five dielectric layer 111 layers including two upper layers and two lower layers based on one dielectric layer at a point at which a central line of the body in the length direction and a central line of the body in the thickness direction meet are extracted among the dielectric layers, five points including two left points and two right points based on one reference point are then determined at equal intervals based on the point at which the central line of the body in the length direction and the central line of the body in the thickness direction meet, and thereafter, thicknesses at the respective points are measured and averaged.

The internal electrodes 121 and 122 may include a first internal electrode 121 and a second internal electrode 122.

The first and second internal electrodes 121 and 122 may be alternately arranged to face each other with the dielectric layer 111 interposed therebetween, the first internal electrode 121 may be exposed to one surface of the body 110 in the second direction, and the second internal electrode 122 may be exposed to an other surface of the body 110 in the second direction.

Referring to FIG. 2, the first internal electrode 121 may be disposed to be spaced apart from the other surface of the body 110 in the second direction by a certain distance, and the second internal electrode 122 may be disposed to be spaced apart from one surface of the body 110 in the second direction by a certain distance. At this time, the first and second internal electrodes 121 and 122 may be electrically separated from each other by the dielectric layer 111 disposed therebetween.

The body 110 may be formed by alternately stacking ceramic green sheets on which the first internal electrode 121 is printed and ceramic green sheets on which the second internal electrode 122 is printed and then sintering the same.

A material forming the internal electrodes 121 and 122 is not particularly limited, and a material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing an internal electrode conductive paste including at least one of nickel (Ni), copper (Cu), palladium (Pd), silver (Ag), gold (Au), platinum (Pt), tin (Sn), tungsten (W), titanium (Ti), and alloys thereof on a ceramic green sheet. As a printing method of the internal electrode conductive paste, a screen printing method or a gravure printing method may be used but the present disclosure is not limited thereto.

An average thickness te of the internal electrodes 121 and 122 is not particularly limited and may vary depending on the purpose. In order to miniaturize the multilayer electronic component 100, the average thickness te of the internal electrodes 121 and 122 may be 0.35 μm or less, and in order to improve the reliability of the multilayer electronic component 100 under high temperature and high voltage, the average thickness te of the internal electrodes 121 and 122 may be 3 μm or more.

The average thickness te of the internal electrodes 121 and 122 is obtained as follows. In an image of a cross-section of the body 110 in length and thickness directions (L-T) taken at the center of the body 110 in the width direction scanned with a scanning electron microscope, a total of five internal electrode layers including two upper layers and two lower layers based on one internal electrode layer at a point at which a central line of the body in the length direction and a central line of the body in the thickness direction meet are extracted among the internal electrode layers, five points including two left points and two right points based on one reference point are then determined at equal intervals based on the point at which the central line of the body in the length direction and the central line of the body in the thickness direction meet, and thereafter, thicknesses at the respective points are measured and averaged.

Referring to FIGS. 2 and 3, in the body 110, a region in which the internal electrodes 121 and 122 overlap in the first direction may be defined as a capacitance formation portion Ac.

The capacitance formation portion Ac may play a role of forming capacitance as the first and second internal electrodes 121 and 122 are arranged to overlap in the first direction.

Meanwhile, cover portions 112 and 113 may be provided on one surface and the other surface of the capacitance formation portion Ac in the first direction.

The cover portions 112 and 113 may be formed by stacking a single dielectric layer or two or more dielectric layers on the upper and lower surfaces of the capacitance formation portion Ac in the thickness direction and may basically play a role of preventing damage to the internal electrodes due to physical or chemical stress.

The cover portions 112 and 113 may not include an internal electrode and may include the same material as the dielectric layer 111.

That is, the cover portions 112 and 113 may include a ceramic material, and for example, may include the same material as the dielectric layer 111.

Meanwhile, a thickness of each of the cover portions 112 and 113 is not particularly limited. For example, the thickness of each of the cover portions 112 and 113 may be 20 μm or less, respectively.

An average thickness of the cover portions 112 and 113 may refer to a size in the first direction and may be an average value obtained by measuring sizes of the cover portions 112 and 113 measured at five equally spaced points above and below the capacitance formation portion Ac.

Margin portions 114 and 115 may be arranged on one surface and the other surface of the capacitance formation portion Ac in the third direction.

As shown in FIG. 3, the margin portions 114 and 115 may refer to regions between the ends of the first and second internal electrodes 121 and 122 and a boundary surface of the body 110 in end surfaces of the body 110 in the second direction.

The margin portions 114 and 115 may play a role in preventing damage to the internal electrodes due to physical or chemical stress.

The margin portions 114 and 115 may be formed by forming the internal electrodes by applying a conductive paste to the ceramic green sheet except for a region in which the margin portions are to be formed.

In addition, in order to suppress a step difference caused by the internal electrodes 121 and 122, the internal electrodes may be cut to be exposed to the end surfaces of the body in the third direction after stacking, and then a single dielectric layer or two or more dielectric layers may be stacked on both side surfaces of the capacitance formation portion Ac in the third direction (the width direction) to form the margin portions 114 and 115.

Meanwhile, a width of the margin portions 114 and 115 is not particularly limited. For example, an average width of the margin portions 114 and 115 may be 20 μm or less, respectively.

An average width of the margin portions 114 and 115 may refer to an average size of a region in which the internal electrode is spaced from the fifth surface in the third direction and an average size of a region in which the internal electrode is spaced from the sixth surface in the in the third direction and may be an average value of the sizes of the margin portions 114 and 115 in the third direction measured at five equally spaced points on the side surface of the capacitance formation portion Ac.

Referring to FIG. 4, when a direction, perpendicular to the first direction, is the second direction and a direction, perpendicular to the first and second directions, is the third direction, the body 110 may include first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first and second surfaces 1 and 2, connected to the third and fourth surfaces 3 and 4, and opposing each other in the third direction.

Although a specific shape of the body 110 is not particularly limited, as shown, the body 110 may have a hexahedral shape or a similar shape. Due to the shrinkage of ceramic powder included in the body 110 during a sintering process, the body 110 may not have a perfectly hexahedral shape but may have a substantially hexahedral shape.

Referring to FIG. 5, extension portions 141 and 142 may be arranged on the body 110. The extension portions 141 and 142 may be arranged on the third surface 3 and the fourth surface 4, which are surfaces of the body opposing in the second direction to cover the end portions of the internal electrodes 121 and 122 in the second direction.

Referring to FIGS. 1 and 6, in an exemplary embodiment in the present disclosure, the extension portions 141 and 142 may include a plurality of lead electrodes 141a and 142a arranged at intervals in the second direction, a plurality of via electrodes 141b and 142b connecting the plurality of lead electrodes 141a and 142a, and an insulating portions 141c and 142c covering the plurality of lead electrodes 141a and 142a.

In an exemplary embodiment, the extension portions 141 and 142 are arranged on the third and fourth surfaces 3 and 4 of the body 110 opposing in the second direction, and the plurality of lead electrodes 141a and 142a may be in contact with the internal electrodes 121 and 122 on the third and fourth surfaces 3 and 4 of the body 110. Accordingly, the internal electrodes 121 and 122 may not be in direct contact with the external electrodes 131 and 132 to be described below and may be in direct contact with the plurality of lead electrodes 141a and 142a.

The plurality of lead electrodes 141a and 142a may be in direct contact with the internal electrodes to play a role of securing electrical connectivity.

The plurality of lead electrodes 141a and 142a may include a conductive metal. The type of the conductive metal included in the plurality of lead electrodes 141a and 142a is not particularly limited, but in an exemplary embodiment, the plurality of lead electrodes 141a and 142a may include one or more of nickel (Ni), copper (Cu), palladium (Pd), silver (Ag), gold (Au), platinum (Pt), tin (Sn), tungsten (W), titanium (Ti), and alloys thereof.

The plurality of via electrodes 141b and 142b may connect the plurality of lead electrodes 141a and 142a, and specifically, the plurality of via electrodes 141b and 142b may be arranged between a pair of lead electrodes adjacent to each other among the plurality of lead electrodes 141a and 142a.

The plurality of via electrodes 141b and 142b may include a conductive metal. The type of the conductive metal included in the plurality of via electrodes 141b and 142b is not particularly limited, but in an exemplary embodiment, the plurality of via electrodes 141b and 142b may include one or more of nickel (Ni), copper (Cu), palladium (Pd), silver (Ag), gold (Au), platinum (Pt), tin (Sn), tungsten (W), titanium (Ti), and alloys thereof.

The insulating portions 141c and 142c may cover the plurality of lead electrodes 141a and 142a. Specifically, the insulating portions 141c and 142c may be arranged to fill a region between the plurality of lead electrodes 141a and 142a in which the plurality of via electrodes 141b and 142b are not formed and to cover the surfaces of the plurality of lead electrodes 141a and 142a. Accordingly, the moisture resistance reliability of the multilayer electronic component 100 may be secured.

The insulating portions 141c and 142c may include the same dielectric material as the dielectric layer 111, but are not limited thereto, and may include a material having excellent insulation or rigidity.

As an example of a method for forming the extension portions 141 and 142 on the body 110, a sheet for forming the extension portion formed by printing a plurality of lead electrode patterns on a ceramic sheet with another ceramic sheet interposed therebetween may be formed by compressing and sealing the sheet on the body 110 and then sintering the same. At this time, a formation region of the plurality of lead electrodes 141a and 142a may be adjusted by adjusting a printing region of the lead electrode patterns, and a separate ceramic sheet may be printed on the ceramic sheet on which the plurality of lead electrodes 141a and 142a are not formed. Meanwhile, the via electrodes 141b and 142b may be formed by forming a via hole through a laser drill or a perforator every time the lead electrode pattern is printed in two layers and applying a conductive paste to the via hole or filling the via hole with a conductive material using a method, such as plating. Meanwhile, the via electrodes 141b and 142b may also be formed by forming a via hole to penetrate through all of the plurality of lead electrode patterns after all of the plurality of lead electrode patterns are printed and then filling the via hole with a conductive material. In the related art, in order to minimize the proportion of the external electrodes in the entire multilayer ceramic capacitor and to minimize the region in which the external electrodes are exposed to the outside of the multilayer ceramic capacitor, there has been an attempt to introduce a structure in which a separate lead electrode is formed on the cross-section of the body in which one end of the internal electrode is exposed, the lead electrode is covered with a ceramic layer, and the lead electrode is exposed only on one surface in the thickness direction. In the case of having such a structure, the proportion of the external electrodes in the multilayer ceramic capacitor may be minimized and the moisture resistance reliability may be improved, but it may be difficult to sufficiently secure the electrical connectivity between the internal electrode and the lead electrode and the electrical connectivity between the lead electrode and the external electrode, which may result in a reduction in the ESR of the multilayer ceramic capacitor.

According to an exemplary embodiment in the present disclosure, since a plurality of lead electrodes are formed to be spaced apart from each other in the second direction, a contact area between the external electrodes 131 and 132 and the plurality of lead electrodes 141a and 142a may increase. Accordingly, the ESR of the multilayer electronic component 100 may be reduced.

According to an exemplary embodiment in the present disclosure, since the plurality of lead electrodes 141a and 142a are connected through the plurality of via electrodes 141b and 142b, the connectivity between the plurality of lead electrodes 141a and 142a may be secured and the total area of the plurality of lead electrodes 141a and 142a may increase. Accordingly, the ESR of the multilayer electronic component 100 may be reduced.

That is, according to an exemplary embodiment in the present disclosure, when the extension portions 141 and 142 include a plurality of lead electrodes 141a and 142a spaced apart from each other in the second direction and a plurality of via electrodes 141b and 142b connecting the plurality of lead electrodes 141a and 142a, the contact area between the external electrodes 131 and 132 and the plurality of lead electrodes 141a and 142a may increase, connectivity between the plurality of lead electrodes 141a and 142a may be secured, and the total area of the plurality of lead electrodes 141a and 142a may increase, so that the effect of reducing the ESR of the multilayer electronic component 100 may be remarkable.

In an exemplary embodiment, the plurality of lead electrodes 141a and 142a may be in contact with the external electrodes 131 and 132 on one surface of the extension portions 141 and 142 in the first direction. Through this, the proportion of the external electrodes 131 and 132 in the entire multilayer electronic component 100 may be minimized. At this time, the external electrodes 131 and 132 may be arranged only on one surface of the extension portions 141 and 142 in the first direction and may not be arranged on both surfaces of the extension portions 141 and 142 in the second direction and on both surfaces of the extension portions 141 and 142 in the third direction.

In an exemplary embodiment, one end of the plurality of lead electrodes 141aand 142a in the first direction may be exposed to one surface of the extension portions 141 and 142 in the first direction, and the other end of the plurality of lead electrodes 141a and 142a in the first direction may not be exposed to the other surface of the extension portions 141 and 142 in the first direction. Accordingly, the thickness of the multilayer electronic component 100 in the first direction may be minimized. Meanwhile, when the other end of the plurality of lead electrodes 141a and 142a in the first direction is not exposed to the other surface of the extension portions 141 and 142 in the first direction, the plurality of lead electrodes 141a and 142a may cover only a portion of each of the one surface and the other surface of the body 110 in the second direction. At this time, it is preferable that the plurality of lead electrodes 141a and 142a are arranged to cover the ends of the internal electrodes in the second direction, and portions not covered with the plurality of lead electrodes 141a and 142a may be covered with the insulating portions 141c and 142c.

In an exemplary embodiment, the plurality of via electrodes 141b and 142b may be arranged between a pair of lead electrodes adjacent to each other among the plurality of lead electrodes 141a and 142a, and diameters of the plurality of via electrodes 141b and 142b may have a maximum value on a surface in which the plurality of via electrodes 141b and 142b are in contact with the lead electrode disposed to be closer to the body 110 among the pair of lead electrodes adjacent to each other.

Referring to FIG. 6, a plurality of via electrodes 141b and 142b may be arranged between a pair of adjacent lead electrodes among the plurality of lead electrodes 141a and 142a. Specifically, a plurality of via electrodes 141b-1 may be arranged between a pair of adjacent lead electrodes 141a-1 and 141a-2, and a plurality of via electrodes 141b-2 may be arranged between a pair of adjacent lead electrodes 141a-2 and 141a-3. At this time, a diameter of the plurality of via electrodes 141b and 142b may have a maximum value on a surface in contact with an lead electrode disposed to be closer to the body 110 among the pair of adjacent lead electrodes. For example, the diameter of the plurality of via electrodes 141b-1 may be larger on a surface in which the plurality of via electrodes 141b-1 and the lead electrode 141a-1 contact each other than on a surface in which the plurality of via electrodes 141b-1 and the lead electrode 141a-2 contact each other, and the diameter of the plurality of via electrodes 141b-1 may have a maximum value on a surface in which the plurality of via electrodes 141b-1 and the lead electrode 141a-1 contact each other.

In an exemplary embodiment, in the cross-sections of the multilayer electronic component 100 in the first and second directions, the plurality of via electrodes 141b and 142b may have a trapezoidal shape. At this time, the two bottom sides of the trapezoid may be formed at the boundaries between the plurality of via electrodes 141b and 142b and the lead electrode 141a and 142a.

Meanwhile, referring to FIG. 6, the plurality of lead electrodes 141a may

include a first lead electrode 141a-1 in contact with the internal electrode 121, a second lead electrode 141a-2 spaced apart from the first lead electrode 141a-1 in the second direction, and a third lead electrode 141a-3 spaced apart from the second lead electrode 141a-2 in the second direction.

In FIG. 6, the plurality of lead electrodes 141a of the present disclosure are represented as three layers, but the number of lead electrodes 141a in the present disclosure is not limited to three.

At this time, the plurality of via electrodes 141b may include a first via electrode 141b-1 connecting the first lead electrode 141a-1 and the second lead electrode 141a-2 and a second via electrode 141b-2 connecting the second lead electrode 141a-2 and the third lead electrode 141a-3.

In an exemplary embodiment, at least a portion of the first via electrode 141b-1 and at least a portion of the second via electrode 141b-2 may overlap in position in the second direction. Accordingly, the connectivity between the plurality of lead electrodes 141a and 142a may be improved.

In an exemplary embodiment, the plurality of lead electrodes 141a and 142a may be arranged to pass both ends of the internal electrodes 121 and 122 in the first direction. Specifically, the plurality of lead electrodes 141a and 142a may be arranged to pass the end portion of the internal electrode exposed at an outermost portion in the first direction among the end portions of the internal electrodes exposed in the second direction. Accordingly, a sufficient contact area may be secured between the plurality of lead electrodes 141a and 142a and the internal electrodes 121 and 122.

Referring to FIG. 6, the maximum length of the extension portions 141 and 142 in the second direction is represented as LM, the maximum length of the plurality of lead electrodes 141a and 142a in the second direction is represented as LC, the maximum thickness of the extension portions 141 and 142 in the first direction is represented as TM, and the maximum thickness of the plurality of lead electrodes 141a and 142a in the first direction is represented as TC.

At this time, in an exemplary embodiment, LM and LC may satisfy 0.01<LC/LM<0.9.

If LC/LM is less than 0.01, the connectivity between the internal electrodes 121 and 122 and the plurality of lead electrodes 141a and 142a may be reduced or the ESR of the multilayer electronic component 100 may increase. If LC/LM exceeds 0.9, the multilayer electronic component 100 may become vulnerable to external impact.

Accordingly, in an exemplary embodiment, by making LM and LC satisfy 0.01<LC/LM<0.9, the increase in the ESR of the multilayer electronic component 100 and the problem of the vulnerability to external impact may be alleviated.

In addition, in an exemplary embodiment, TM and TC may satisfy 0.85<TC/TM<0.95.

There is no need to specifically limit a lower limit value of TC/TM, but it may be more advantageous for capacitance implementation when TC/TM exceeds 0.85. If TC/TM exceeds 0.95, a penetration path of external moisture may be shortened, which may deteriorate the moisture resistance reliability of the multilayer electronic component 100.

Accordingly, in an exemplary embodiment, by making TM and TC satisfy 0.85<TC/TM<0.95, sufficient capacitance of the multilayer electronic component 100 may be implemented while deterioration of moisture resistance reliability is prevented.

LM, which is the maximum length of the extension portions 141 and 142 in the second direction, LC, which is the maximum length of the plurality of lead electrodes 141a and 142a in the second direction, TM, which is the maximum thickness of the extension portions 141 and 142 in the first direction, and TC, which is the maximum thickness of the plurality of lead electrodes 141a and 142a in the first direction, may be measured in the cross-sections in the first and second directions polished to the center of the multilayer electronic component 100 in the third direction. LM may be measured as the maximum length from one end of the extension portions 141 and 142 to the other end in the second direction, LC may be measured as the maximum length from one end to the other end of the plurality of lead electrodes 141a and 142a in the second direction, TM may be measured as the maximum thickness from one end to the other end of the extension portions 141 and 142 in the first direction, and TC may be measured as the maximum thickness from one end to the other end of the plurality of lead electrodes 141a and 142a in the first direction.

The external electrodes 131 and 132 may be arranged on the extension portions 141 and 142, and the external electrodes 131 and 142 may be in contact with one end of the plurality of lead electrodes 141a and 142a in the first direction.

The external electrodes 131 and 132 may be formed using any material having electrical conductivity, such as metal, and a specific material may be determined by considering electrical characteristics, structural stability, etc., and may further have a multilayer structure.

For example, the external electrodes 131 and 132 may include an electrode layer disposed on the extension portions 141 and 142 and a plating layer formed on the electrode layer.

In addition, the external electrodes 131 and 132 may be formed by a method of attaching a sheet including a conductive metal on the body 110, a method of printing a paste including a conductive metal, etc., but are not limited thereto.

The external electrodes 131 and 132 may use a material having excellent electrical conductivity as a conductive metal and are not particularly limited. For example, the conductive metal may be one or more of nickel (Ni), copper (Cu), palladium (Pd), and alloys thereof.

The size of the multilayer electronic component 100 is not particularly limited. For example, in order to simultaneously achieve miniaturization and high capacitance, the multilayer electronic component 100 may have a size of 0201 (length×width: 0.2 mm×0.1 mm) or less, and in the case of a product for which reliability in a high temperature and high pressure environment is important, it may have a size of 3216 (length×width: 3.2 mm×1.6 mm) or more, but is not limited thereto.

Meanwhile, when the maximum thickness of the multilayer electronic component 100 in the first direction is 120 μm or less, it may be difficult to secure the ESR characteristics because the areas of the internal electrodes 121 and 122, the lead electrodes 141a and 142a, and the external electrodes 131 and 132 are reduced. However, in an exemplary embodiment in the present disclosure, the ESR characteristics may be improved by disposing the extension portions on the body 110 and allowing the extension portions to include the plurality of lead electrodes spaced apart in the second direction, a plurality of via electrodes connecting the plurality of lead electrodes, and the insulating portion covering the plurality of lead electrodes. Therefore, even when the maximum thickness of the multilayer electronic component 100 in the first direction is 120 μm or less, the reduction of the ESR characteristics may be prevented.

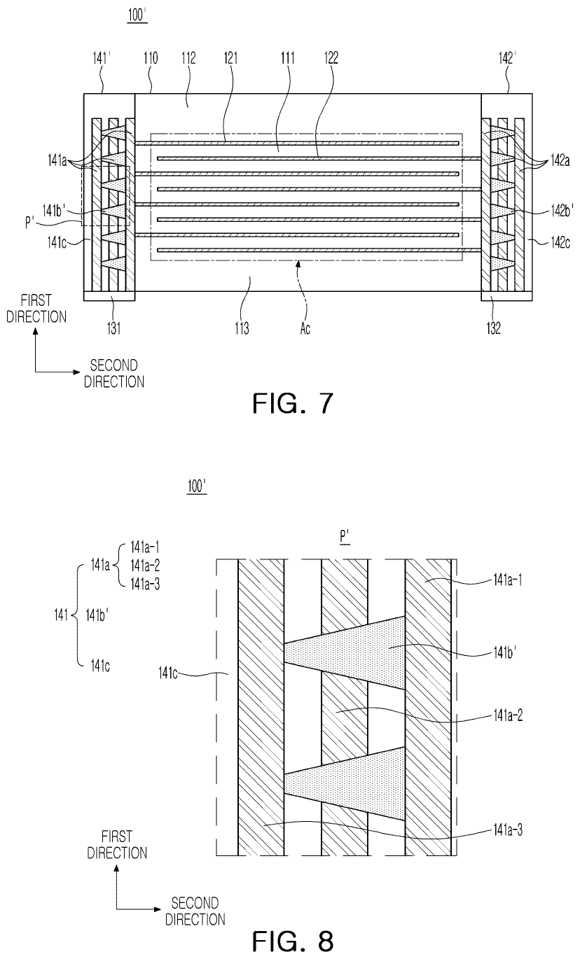

FIG. 7 is a cross-sectional view of a multilayer electronic component corresponding to FIG. 2 according to an exemplary embodiment.

FIG. 8 is an enlarged view of region P′ of FIG. 7.

Referring to FIGS. 7 and 8, a multilayer electronic component 100′ according to an exemplary embodiment may include extension portions 141′ and 142′ arranged on the body 110 and external electrodes 131 and 132 arranged on the extension portions 141′ and 142′, and the extension portions 141′ and 142′ may include a plurality of lead electrodes 141a and 142a arranged to be spaced apart in the second direction, a plurality of via electrodes 141b′ and 142b′ connecting the plurality of lead electrodes 141a and 142a, and insulating portions 141c and 142c covering the plurality of lead electrodes 141a and 142a, and the plurality of via electrodes 141b′ and 142b′ may be arranged continuously in the second direction. Accordingly, the connectivity between the plurality of lead electrodes 141a and 142a may be further improved.

In the case in which the plurality of via electrodes 141b′ and 142b′ are arranged sequentially in the second direction as in the exemplary embodiment, the plurality of via electrodes 141b′ and 142b′ may be arranged to penetrate through the lead electrodes arranged between the lead electrodes arranged at both end portions among the plurality of lead electrodes 141a and 142a in the second direction. Referring to FIG. 8, the plurality of via electrodes 141b′ may be arranged to penetrate through the lead electrodes 141a-2 disposed between the lead electrodes 141a-3 and 141a-1 arranged at both end portions among the plurality of lead electrodes 141a in the second direction.

One of the various effects of the present disclosure is to reduce the equivalent series resistance (ESR) of a multilayer electronic component by improving the connectivity between the internal electrodes and the lead electrodes.

Although the exemplary embodiments in the present disclosure have been described in detail above, the present disclosure is not limited to the exemplary embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or one example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular exemplary embodiments only and are not intended to limit the example exemplary embodiments. As used herein, the singular forms “a,” “an” and “the” are intended to include the plural forms as well, unless the context clearly indicates otherwise.

What is claimed is:

1. A multilayer electronic component comprising:
a body including a dielectric layer and internal electrodes alternately arranged in a first direction with the dielectric layer interposed therebetween;
an extension portion disposed on a surface the body disposed in a second direction perpendicular to the first direction; and
an external electrode disposed on a surface of the extension portion, disposed in the first direction,
wherein the extension portion includes a plurality of lead electrodes spaced apart in the second direction, a plurality of via electrodes connecting the plurality of lead electrodes, and an insulating portion covering the plurality of lead electrodes, and
wherein one of the plurality of the lead electrodes contacts the internal electrodes in the second direction.

2. The multilayer electronic component of claim 1, wherein the plurality of lead electrodes are in contact with the external electrode.

3. The multilayer electronic component of claim 1, wherein one end of the plurality of lead electrodes in the first direction is exposed to one surface of the extension portion in the first direction, and the other end of the plurality of lead electrodes in the first direction is not exposed to the other surface of the extension portion in the first direction.

4. The multilayer electronic component of claim 1, wherein the plurality of via electrodes are arranged between a pair of adjacent lead electrodes among the plurality of lead electrodes, and a diameter of the plurality of via electrodes has a maximum value on a surface in which the plurality of via electrodes contact the lead electrode disposed to be closer to the body among the pair of adjacent lead electrodes.

5. The multilayer electronic component of claim 1, wherein the plurality of via electrodes are arranged continuously in the second direction.

6. The multilayer electronic component of claim 1, wherein the plurality of lead electrodes include a first lead electrode in contact with the internal electrode, a second lead electrode spaced apart from the first lead electrode in the second direction, and a third lead electrode spaced apart from the second lead electrode in the second direction.

7. The multilayer electronic component of claim 6, wherein the plurality of via electrodes include a first via electrode connecting the first lead electrode and the second lead electrode and a second via electrode connecting the second lead electrode and the third lead electrode.

8. The multilayer electronic component of claim 7, wherein at least a portion of the first via electrode is located to overlap at least a portion of the second via electrode in the second direction.

9. The multilayer electronic component of claim 1, wherein, in cross-sections of the multilayer electronic component in the first direction and the second direction, the plurality of via electrodes have a trapezoidal shape.

10. The multilayer electronic component of claim 1, wherein the plurality of lead electrodes are arranged to pass both ends of the internal electrode in the first direction.

11. The multilayer electronic component of claim 1, wherein 0.01<LC/LM<0.9, in which LM is a maximum length of the extension portion in the second direction and LC is a maximum length of the plurality of lead electrodes in the second direction.

12. The multilayer electronic component of claim 1, wherein 0.85<TC/TM<0.95, in which TM is a maximum thickness of the extension portion in the first direction and TC is a maximum thickness of the plurality of lead electrodes in the first direction.

13. The multilayer electronic component of claim 1, wherein a maximum thickness of the multilayer electronic component in the first direction is 120 μm or less.

14. The multilayer electronic component of claim 1, wherein the external electrode is disposed only on one surface of the extension portion in the first direction.

15. The multilayer electronic component of claim 1, wherein the extension portion is disposed on one surface and the other surface of the body opposing in the second direction, and the plurality of lead electrodes are in contact with the internal electrodes on one surface and the other surface of the body opposing in the second direction.

16. A multilayer electronic component, comprising:
a body including internal electrodes stacked in a thickness direction with dielectric layers disposed therebetween;
extension portions disposed on length-wise opposing end surfaces of the body, each of the extension portions comprising:
an external electrode disposed on bottom surface of corresponding extension portion,
lead electrodes disposed parallel to corresponding end surface of the body, one of the lead electrodes contacting internal electrodes at the corresponding end surface of the body, the lead electrodes contacting the external electrode at the bottom surface and being spaced apart from the top surface, and
via electrodes disposed between adjacent lead electrodes, forming an electric contact between the lead electrodes.

17. The multilayer electronic component of claim 16, wherein 0.01<LC/LM<0.9, in which LM is a maximum dimension of the extension portion in the length direction and LC is a maximum dimension of the lead electrodes in the length direction.

18. The multilayer electronic component of claim 16, wherein 0.85<TC/TM<0.95, in which TM is a maximum dimension of the extension portion in the thickness direction and TC is a maximum dimension of the lead electrodes in the thickness direction.
